(19) United States
(12) Patent Application Publication
(10) Pub. No.: US 2004/0046018 A1
(43) Pub. Date: Mar. 11, 2004

(54) System and method for electronic lock access

(75) Inventor: Bob M. Dobbins, Villanova, PA (US)

Correspondence Address: PRIEST & GOLDSTEIN PLLC, 5015 SOUTHPARK DRIVE, SUITE 230, DURHAM, NC, 27713-7736, US

(73) Assignee: Ellenby Technologies, Inc., West Deptford, NJ

(21) Appl. No.: 10/655,525

(22) Filed: Sep. 4, 2003

Related U.S. Application Data
(60) Provisional application No. 60/408,544, filed on Sep. 5, 2002.

(51) Int. Cl. G06K 7/01

(52) U.S. Cl. 235/382.5

(57) ABSTRACT

An electronic lock system which allows unattended dispensing of user determined key codes is described. These user determined key codes are then utilized by the user to gain access to a particular room or area. In one aspect of the present invention, a secure lock system for providing user access to an area includes a terminal interfacing with a user and receiving a user determined key code from the user. An access locking device blocks access to the area, but after the user inputs the user determined key code to the access locking device the access device unlocks and provides access to the area.

The present application claims the benefit of U.S. Provisional Application Serial No. 60/408,544 entitled “Personal ID Electronic Lock System Patent Disclosure” and filed Sep. 5, 2002 which is incorporated herein by reference in its entirety.

### FIELD OF THE INVENTION

The present invention relates generally to providing an improved electronic lock system. More particularly, the present invention relates to an electronic lock system which provides increased security, reduced costs, and allows unattended dispensing of user determined key codes allowing user access to a particular room or area. This system is advantageously suited to the rental of motel rooms during off hours and the like.

### BACKGROUND OF THE INVENTION

There are many applications for the dispensing of keys to allow access for limited periods of time to such things as motel or hotel rooms, lockers, secure cabinets, secured facilities and the like. In these cases, the intent is to have the same room, locker, cabinet or facility accessed at a future time by another person. In many cases, the key is dispensed in return for money or to an authorized party. Various systems exist addressing these situations.

One common technique involves the issuing of standard metal keys to the people who check into a hotel. This approach has a number of disadvantages, including the ability of an unauthorized person to duplicate keys or having users break, lose or keep keys. Additionally, it is costly to replace the lock barrel of a lock if the key needs to be changed due to a security breach. In the case of motels, for example, access to a room by someone who kept their key from a prior visit will likely provide entrance to a room currently rented by someone else. The problem is further highlighted by the fact that many such keys have a guarantee of return postage and an address for their return if found so that if someone with the desire to rob a hotel room finds the key, that person knows where to take the key.

To provide increased security, many applications that formerly used standard metal keys have migrated to one of several intelligent key solutions. One such solution is a hardwired, bidirectional communication system with online access control and centralized monitoring. This system uses a nickel-silver alloy “key” which communicates with the lock's keyreader using an infrared optical scheme. This signal is communicated to a unit which is tied to a central computer and is located near the door lock. The computer controls all the locks in the system. This system requires a central power supply and uses batteries for backup. Security is achieved as the key code can be changed for all the locks quickly as they are tied to the computer. The “keys” are robust and not easily broken. This system is known as the Millennium 9000 Hotel Security System from Ilco Unican using keys known as Marlok keys.

A second such solution offered by VingCard is controlled by software resident in the locks and activated by key cards coded on a Ving Card 2100. Each lock contains a card reader and electronic lock control module connected to a motor actuated lock mechanism. The lock is opened by industry standard magnetic stripe cards. Each keycard is encrypted with a unique code. Upon insertion of the keycard into the lock for the first time, the lock is immediately recoded, canceling entry authorization for the previous keycard. An authorized starting time and finishing time can be coded up to 12 months in advance.

Additional systems exist that use magnetic cards and/or smart cards. A keyless solution is offered by Kaba-Ilco through their Oracode 4400™ system. This system uses a host computer to generate 6 digit codes that the user must remember or write down. The code contains the room number and authorized start and end dates in an encrypted form. The locks are standalone devices with the ability to decode the room and valid dates. If the room and dates are a match, the lock is opened. The code holder can reprogram their code once the code is used.

Each of these systems seek to solve the problem of security by allowing the keys to be reprogrammed between each use. All of these solutions using physical keys suffer from several limitations. In most of the present technology solutions, multiple keys are easily generated. At a motel for example, even when using the supposedly high security solutions, the clerk routinely asks how many keys are needed. Clearly, security is breached if any of these keys are misplaced or if unauthorized keys are encoded. Further, the risk of having less than trustworthy clerks can lead to easy access to the secure environment. Additionally, these systems can be defeated leading to the keys being issued without routinely changing the codes for each room or use change. A second limitation of each of these systems is the continued reliance on a physical key of some type. Lost keys, defective keys, and failed keys lead to users being dissatisfied. A third limitation of each of these systems is that in all cases the key has to be issued by a person. This requirement adds to the security risks from another perspective. In the case of motels, by way of example, a clerk is required around the clock to service customers arriving in the middle of the night. In many areas, the security of the clerk is greatly compromised, as they are often the only person on duty during the hours most attractive to thieves and other unsavory people. Having to keep people on duty during off hours also adds a large cost to maintaining this type of business. Conversely, if a clerk is not kept on duty to save costs, then business may be lost.

The use of many of the current technology secure electronic lock systems requires a significant investment in hardwiring each of the locks to a central system. In these cases, a system failure can render each of the key holders with unusable keys. Power failures can likewise cause the system to fail.

In the case of the existing keyless solutions, the user must remember a code. Since the locks are preprogrammed with the decryption algorithm and the information it receives is predetermined, such as room number, valid dates, and the like, for example, the system has no flexibility on the codes generated. Additionally, anyone with access to the code generator can create additional valid codes for the locks.

Another aspect of lock systems in general and those for use by a transient consumer such as those typical for motels, hotels, lockers, and the like, specifically is the direct relationship between the need for key issuers for applications where the location of the lock is remote from the location of the keys. Only in the case where the lock and key issuer are in close proximity has unattended key dispensing been used, for example, the vending of a key for money at airport lockers. In hotels and motels, the determination of the room or facility availability, the issuing of the key, and the acceptance of payment have required a clerk. As described above, most keys, even electronic cards and the like need to be programmed by a programming device with the authority of an issuing person.

### SUMMARY OF THE INVENTION

The present invention provides techniques for an electronic lock system which allows unattended dispensing of user determined key codes. These user determined key codes are then utilized by the user to gain access to a particular room or area. In one aspect of the present invention, a secure lock system for providing user access to an area includes a terminal interfacing with a user and receiving a user determined key code from the user. An access locking device blocks access to the area, but after the user inputs the user determined key code to the access locking device the access device unlocks and provides access to the area

It is an objective of the current invention to provide a secure electronic lock system which limits the ability to unlock the access door to only the purchaser or authorized key holder, or to an otherwise authorized personnel.

A further objective of the current invention is to provide a technique to allow potential key holders to purchase a key without requiring a human attended dispensing system.

It is yet another objective to provide an unattended key dispensing unit which will accept cash or credit or a previously authorized code to enable the issuing of a secure virtual key, or key code.

It is a further object to allow the potential purchaser to chose between several alternatives of differing values and differing durations of access authority without interfacing with humans while maintaining keyless security.

Another object of the current invention is to provide a secure user determined code to allow entry to the access area.

Another object of the current invention is to provide a wireless communications system between the key issuing device and the access points.

A further object of the current invention is to provide an encrypted communication system between the key issuing device and the access point.

It is also an object of the current invention to provide an intelligent lock which can communicate securely with the issuing device and decode the user entered virtual key.

Yet another object of the current invention is to provide an unattended virtual key dispensing system which can be both easily and securely used by people of any educational level.

Other features and advantages of the present invention are described further below and will be readily apparent by reference to the following detailed description and accompanying drawings.

### BRIEF DESCRIPTION OF THE DRAWINGS

FIG. 1A illustrates an unattended key code dispensing terminal in accordance with the present invention;

FIG. 1B illustrates a key code dispensing system in accordance with the present invention;

FIG. 2 is a block diagram of a key code dispensing system in accordance with the present invention; and

FIGS. 3A-3F show exemplary user interface screens in accordance with the present invention.

### DETAILED DESCRIPTION

The present invention now will be described more fully with reference to the accompanying drawings, in which a preferred embodiment of the invention is shown. This invention may, however, be embodied in various forms and should not be construed as limited to the embodiment set forth herein. Rather, this embodiment is provided so that this disclosure will be thorough and complete, and will fully convey the scope of the invention to those skilled in the art.

The present invention addresses various limitations of current key dispensing systems by providing an advantageous device which allows the consumer to purchase access to a room, locker, or other facility without the need for involvement by a clerk or other person. Access is obtained through the use of a key code which is determined by the user. The dispensing system allows the user to pay for the access key code by cash, credit or the like, select from a choice of rooms or other access points, and choose his or her own access key code. The purchase point of the access key code can be located in a central location, such as a motel lobby. The purchased key code is then transmitted through a wired or preferably wireless system to the access point in a secured manner. When the purchaser of the code arrives at the access point, the purchaser enters their key code on the lock to gain access.

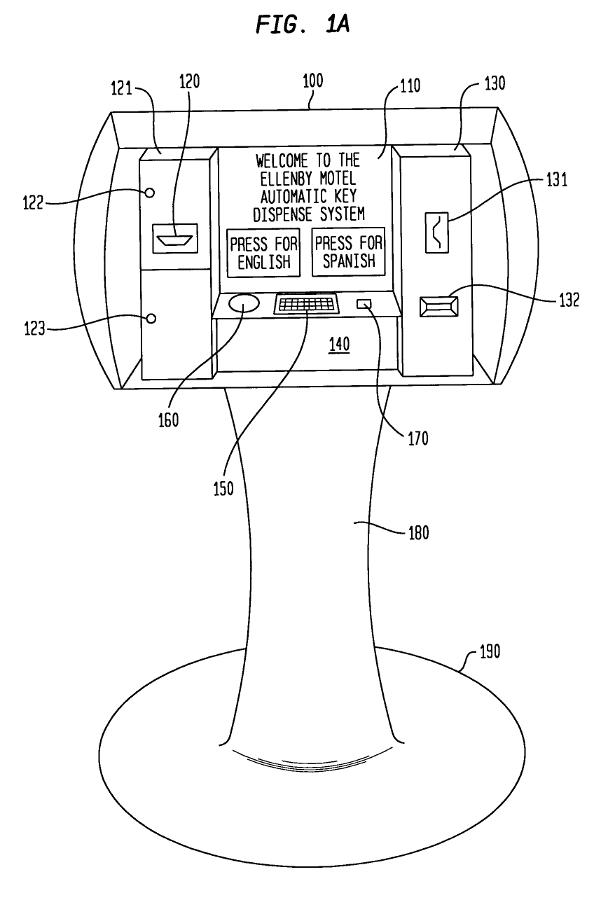

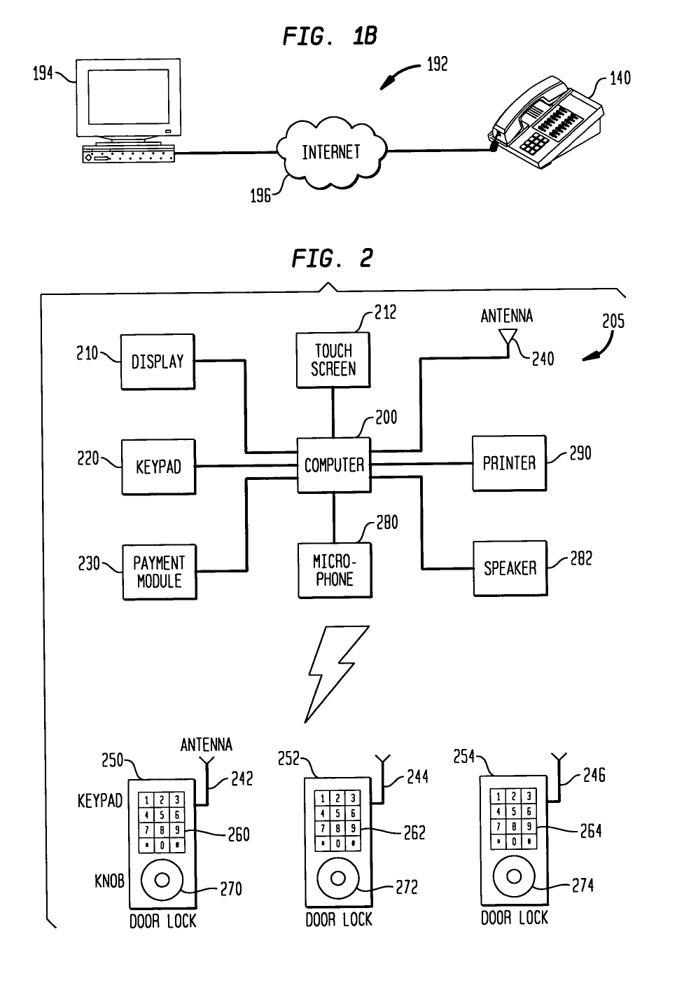

FIG. 1A shows an exemplary stand alone key code dispensing station, or terminal, 100 in accordance with the present invention. The terminal 100 includes a computer 140 interfaced with a monitor 1 10 which provides instructions and prompts for users. Optionally, the monitor 110 can be provided with a touch screen to allow users to respond to choices by touching the monitor directly. In addition or as an alternative to the touch screen, a separate keypad 150 may be provided as an input device for a user to input selections and secure information without being easily observed. Additional techniques for communication with the user are provided through the use of a speaker 160 and a microphone 170 allowing voice communication with the terminal. As further seen in FIG. 1A, a bill acceptor or currency validator 120 is secured in a safe housing 121. Lock 122 provides management access to the bill acceptor 120, and lock 123 provides access to the bills accepted. Credit and debit cards are also accepted through a card reader 131 mounted in housing 130. Receipts are provided through a printer 132 also mounted in housing 130. The key code dispensing station 100 can be mounted on a counter top or on an optional stand 190. Power is provided through wiring which would be routed through a pedestal 180.

In an alternate embodiment, a user may interact with the key code dispensing terminal from a personal computer located at the user's residence, place of business, or the like. FIG. 1B illustrates a key code dispensing system 192 in accordance with the present invention. A personal computer 194 is connected to the key dispensing computer 140 through a network 196, such as the Internet. A user may interact with a hotel's computer using the personal computer 194 to make reservations, select his or her key code, and receive a room number.

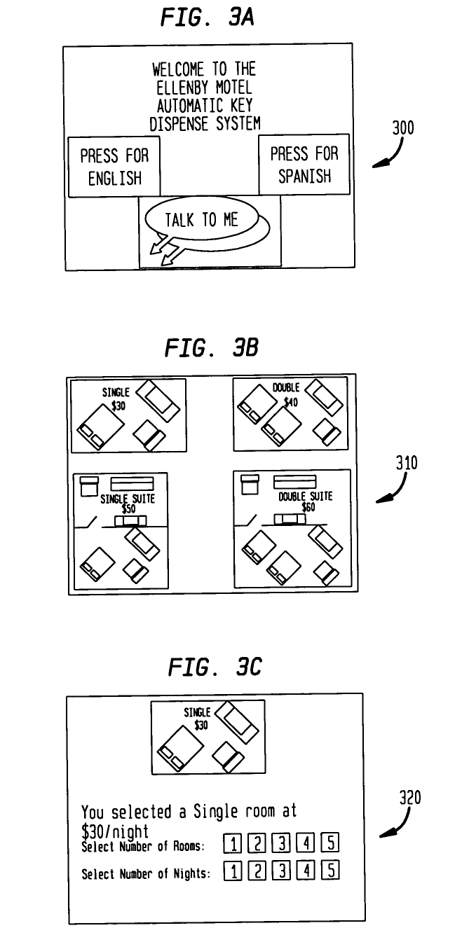

Referring now to FIG. 2, a block diagram of a key code system 205 in accordance with the present invention is shown. The key code dispensing system 205 includes a computer 200 operating as the central processing unit. The computer 200 can be an off the shelf variety such as a personal computer (PC) or a custom designed controller optimized for a particular application and environment. A number of options allow for various user interfaces to the computer. A standard interface would be the use of a display monitor 210. This monitor may suitably be any of a number of commercially available devices including a CRT display, LCD display or the like. A presently preferred option is to have a touch screen 212 on the display to allow users to touch the display in response to questions shown on the monitor. This screen can be integrated into the display or a separate device available commercially.

A key concern in providing a user accessible terminal to be used in a public or open location by the general public is to ensure access is not denied any person or group of people access due to language barriers, educational barriers or physical barriers. In a preferred embodiment of the current invention, the displayed information can be user selectable in a number of languages. Additionally an optional speaker 282 is provided to allow voice communication with the user. Voice communication can be in any programmed language as determined by the location and demographics of the terminal location. Another useful option is a voice response input to the system such as an embedded microphone 280. As controlled by the computer 200, the voice command input is responsive to multiple languages in specific response to the voice output questions relative to language selection.

The advantageous techniques of the present invention allow the user to determine his or her key code and enter it into the system. In one aspect of the present invention, the key code can be entered into the system using the touch screen or voice input. However, in some locations these input choices may not be secure enough to guarantee privacy when entering this key code. As the key code becomes the key allowing access, it is important to provide a secure input mechanism. Although the terminal of the current invention is designed to allow the entry of the code through the touch screen with some privacy by recessing the screen and allowing the code input area to be at least partially physically blocked by the person entering the code, in some cases this may not be deemed sufficient. Voice input clearly will be problematic if the terminal allows close access to people other than the person inputting the code. In these cases, a separate keypad 220 is offered which is not readily visible by persons other than the person entering the key code. This arrangement can be seen more clearly in FIG. 1A where keypad 150 is recessed on a horizontal plane on the terminal.

Returning to FIG. 2, the system 205 also provides apparatus for receiving payment. For example, a payment module 230 can be a combination of payment devices including bill acceptors, coin acceptors, credit and debit card acceptors, and the like. These and other devices are commercially available and provide payment choices consumers are likely familiar with using. Such devices are common in vending machines and kiosks.

A printer 290 is provided to allow receipts for purchases to be generated. In addition, unused credit, proof of purchase and coupons can be printed.

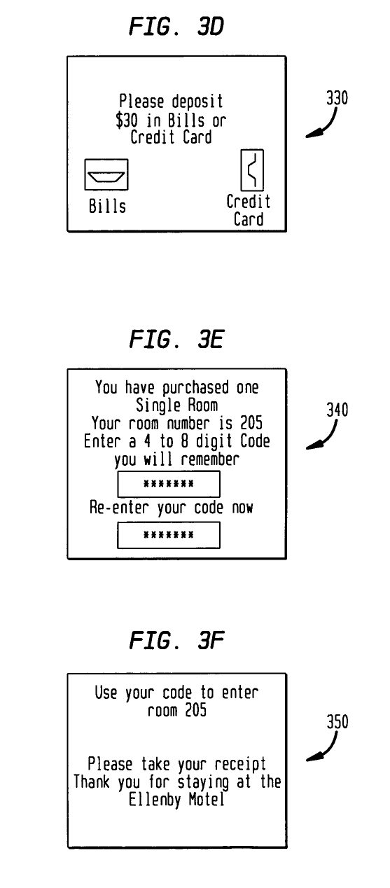

Exemplary user interface screens for use with the present invention are shown in FIGS. 3A through 3F. The terminal may be set up with a welcoming message screen 300 as seen in FIG. 3A. Touch screen selection buttons will allow users to select between a choice of languages or direct the system to speak to the user. Upon selecting the language option or voice option, the screen may be updated to show the choice of rooms or access options along with their price, as shown in screen 310 of FIG. 3B. Alternatively, or in addition to the screen indicating the choices, the voice prompt may describe the rooms as they are touched on the screen. The user selects one of these by touching the screen, or speaking into the microphone. In the case of motel rooms, the next screen may show the selection made and ask for the number of rooms desired and the number of nights needed. These selection choices are shown in screen 320 of FIG. 3C. The user selects a choice of options upon which the system calculates the total amount due.

Screen 330 of FIG. 3D displays the total amount due and solicits payment by one of the payment options offered. As the payment is being made, additional screens not shown can indicate the amount deposited and the remaining amount needed. Additionally, voice prompts can indicate both the amount paid and due. When payment is received, the system will indicate the access point assigned, such as the room number purchased, as shown in screen 340 of FIG. 3E. Additionally, the user is prompted to enter a code which will become their key code. To ensure that the code is entered correctly, the user is prompted to enter the code a second time to confirm the same code is used. As this code can be any code the user will easily remember, there is no need to print or otherwise display the code. The user is the only person with the code, and only an authorized manager will have access to the code. The system will issue a printed receipt for the payment received as shown in screen 350 of FIG. 3F. The receipt will also have a system generated code on it which can be used by the manager to verify the user who might be anonymous as the purchaser of the room. This arrangement will allow recourse by the purchaser in the event the room is unacceptable, the code is forgotten, an overpayment was made, or the like.

The system of the present invention allows payment by credit or debit card and by cash. In most cases, only a bill acceptor will be used. Since no payback means will generally be available, but can be offered as an option, the system will accept overpayment for the room. The amount of the refund due will be printed on the receipt. This receipt can be turned in to the manager in the morning. The manager will be able to enter the printed system code from the receipt into the system in a manager's mode to verify any refund claimed. The manager's mode allows the authorized manager to gain access to the details of all the transactions made on the system. Accountability data and reports can be generated by the system to track cash, room use, market data and the like.

Referring again to FIG. 2, once the user has the room number or other access point authorization, he or she proceeds to the room or access point. At the room door or access point, a lock 250 which consists of a keypad 260 and access knob 270 will respond when the user selected code is entered through the lock keypad 260. In a preferred embodiment of the system, the information from the remote system terminal or computer 200 is transmitted to the lock by a wireless system and antenna 240 through one of several technologies known in the art. Such technologies include Blue Tooth, RF, and optical techniques. The receiving lock is also equipped with a wireless system and antenna 242 to allow bidirectional communications to the host. The code is transmitted to the lock which has the electronic circuitry to support saving this code and comparing it to the code entered by the user. The code transmitted over the wireless system is encrypted to ensure it cannot be readily intercepted. Encryption and decryption technology is known in the art and not discussed further. The door lock may be equipped with a power generating feature which can be enabled by turning the knob or a lever. This technology is known in the art and is not discussed further. It should also be clear that although wireless technology is presently preferred, for cases where the host terminal and the destination access points are relatively close, a wired system can also be used.

The communication between the host and the lock includes a lock identification independent from the code the user selects to open the lock. The host computer, upon authorizing a user to gain access to a specific lock transmits a communication message to the locks on its system requesting a response from the lock it addresses. The message transmitted includes the lock identification code. All of the locks are monitoring communications but each one is programmed to respond only when its own identification code is used. If the correct identification code is used, the lock will respond to the host verifying it received the transmission. The transmission will have included the access code selected by the user, the authorized time and duration to allow the code to gain access. The lock will then respond to this code for the specified time or until it receives another communication from the host further updating the code and access times. In this manner, the lock does not depend on constant communication from the host, but has the ability to allow the user to repeatably gain access to the room while operating in a standalone manner. Thus, a power failure or other system problem will not affect the operation of the lock once a user has purchased access. On the other hand, the host can override the instructions to the lock at any time. A special code can be used to allow housekeeping to have temporary access during specific times without affecting the user's unique code from working. Of course, the manager will also be able to make the room available to other users if the current user leaves early.

Each of the locks 250, 252, 254 shown in FIG. 2 are similar with the exception that each lock has its unique lock identification code. Thus, locks 250, 252, 254 will each respond similarly to the host and to the user. The specific lock which responds to a specific user is determined by the lock identification which the host associates with a room number or access point. The lock identification is not the same generally as the room number but is associated with the room number. This lock identification is also encrypted in all communications to further ensure security.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

I claim:

1. A secure lock system for providing user access to an area comprising:
means for a user to input a user determined key code;
means for providing user access to the area by the user inputting the user determined key code; and
means for communicating the user determined key code from the means for a user to input a user determined key code to the means for providing user access.

2. The secure lock system of claim 1, further comprising:
means for receiving payment from the user in exchange for the user receiving access.

3. The secure lock system of claim 2 wherein the duration of the user access is determined by an amount of payment received.

4. The secure lock system of claim 1 wherein the means for a user to input a user determined key code comprises a personal computer and the means for communicating the user determined key code at least partially comprises the Internet.

5. A secure lock system for providing user access to an area comprising:
a terminal for interfacing with a user and for receiving a user determined key code from the user, said terminal for transmitting the user determined key code to an access locking device;
the access locking device for locking access to the area, said access device for unlocking access to the area after the user inputs the user determined key code to the access locking device.

6. The secure lock system of claim 5 wherein the terminal further comprises a payment acceptor for receiving user payment.

7. The secure lock system of claim 5 wherein the payment acceptor comprises at least one of: a currency acceptor, a credit card reader or debit card reader.

8. The secure lock system of claim 5 wherein the terminal further comprises a user input device for entering the key code, wherein the user input device is at least one of a keypad, a touch screen or a voice input device.

9. The secure lock system of claim 6 wherein access is provided for a limited duration and the duration of the user access is determined by an amount of payment received and an access price.

10. The secure lock system of claim 6 wherein the terminal further comprises a device for issuing a receipt for payments made and a receipt for any credits to be refunded.

11. The secure lock system of claim 5 wherein the terminal communicates with the user in a language selected by the user.

12. The secure lock system of claim 5 wherein said terminal communicates the user determined key code to the access locking device.

13. The secure lock system of claim 12 wherein said terminal communicates an authorized time or duration of access to the access locking device.

14. The secure lock system of claim 5 wherein said terminal communicates the user determined key code to the access locking device through an encrypted communications link.

15. The secure lock system of claim 5 wherein the access locking device comprises a power generating apparatus for providing at least partial power to the access locking device.

16. The secure lock system of claim 5 wherein the access locking device comprises allows temporary limited duration access to someone other than the user.

17. The secure lock system of claim 5 further comprising a personal computer connected to the terminal through the Internet, wherein said user interfaces with the terminal through the personal computer.

18. A method of providing user access to an area comprising the steps of:
determining a key code, by a user;
inputting the key code into a host system, by a user;
transmitting the key code from the host system to the access device;
providing the key code to an access device, by the user; and
allowing access to the area by the access device after the user has provided the key code.

19. The method of claim 18 further comprising the step of:
comparing, by the access device, the key code transmitted from the host system and the key code provided by the user.

20. The method of claim 18 wherein the area is a hotel room having a door and the access device is a lock affixed to the door.
